(19) United States
(12) Patent Application Publication
(10) Pub. No.: US 2010/0138148 A1
(43) Pub. Date: Jun. 3, 2010

(54) NAVIGATION APPARATUS

(76) Inventors: Kumi Nishibashi, Tokyo (JP); Naomiki Komatsu, Tokyo (JP); Yoshiki Akashi, Tokyo (JP); Takashi Irie, Tokyo (JP)

Correspondence Address: BIRCH STEWART KOLASCH & BIRCH, PO BOX 747, FALLS CHURCH, VA, 22040-0747, US

(21) Appl. No.: 12/523,044

(22) PCT Filed: Nov. 22, 2007
(86) PCT No.: PCT/JP2007/072686

§ 371 Date: Jul. 13, 2009

(30) Foreign Application Priority Data
Mar. 23, 2007 (JP) 2007-077214

(51) Int. Cl. G01C 21/36

(52) U.S. Cl. 701/201

(57) ABSTRACT

A navigation apparatus includes an input unit 53 for inputting a destination and a waypoint, a route searching unit 54 for searching for a route to the destination via the waypoint inputted from the input unit, and a route guidance unit 55 for, in a case in which the route which is searched for by the route searching unit is the one which urges a vehicle to make a U-turn at the waypoint, inhibits execution of rerouting while a predetermined condition is satisfied even if the vehicle has deviated from the route because the vehicle did not make a U-turn at the waypoint.

### FIELD OF THE INVENTION

The present invention relates to a navigation apparatus that guides a user to his or her destination. More particularly, it relates to a technology of providing a route guidance in a case in which a route which is acquired through route search with a waypoint being set up is the one which urges the user to make a U-turn at the waypoint.

### BACKGROUND OF THE INVENTION

A conventional navigation apparatus generally makes a research for a route (also referred to as “rerouting” from here on) when the vehicle has deviated from a route during travel along the route acquired through route search. By the way, there is a case in which when such a conventional navigation apparatus sets up a waypoint and makes a search for a route, a route which urges the vehicle to make a U-turn at the waypoint is searched for. In general, even if the vehicle has deviated from the route during travel along the route, the conventional navigation apparatus does not perform rerouting promptly, but performs, rerouting after the vehicle has traveled over, for example, several tens of meters after deviating from the route.

Therefore, even if the vehicle has not made a U-turn at the waypoint during travel along the route which urges the vehicle to make a U-turn at this waypoint, the conventional navigation apparatus does not perform rerouting promptly, but performs rerouting after the vehicle has traveled over several tens of meters after deviating from the route. This means that the conventional navigation apparatus performs rerouting after the vehicle has traveled over several tens of meters after deviating from the route even if the user is still considering whether to make a U-turn. As a result, the conventional navigation apparatus may present a route unsatisfactory to the user, for example, a route along which the vehicle will have to make a detour. In contrast with this, the user may drive the vehicle to deviate from the route with his or her intention, and may desire the conventional navigation apparatus to perform rerouting. In this case, because the conventional navigation apparatus does not perform rerouting until the vehicle travels over, for example, several tens of meters, the conventional navigation apparatus cannot respond to the user's desire quickly.

As a technology of searching for such a route including a U-turn and providing a guidance, patent reference 1 discloses a navigation apparatus that can make a route search and provide a route guidance by taking a U-turn into consideration. In this navigation apparatus, a navigation controller is constructed in such a way as to include a map buffer for storing various data for map display and for route search, a route search processing unit for performing a route searching process, and a guidance route memory. Map data about a correspondence between a U-turn path of a road and an independent link are stored in the map buffer, and the route search processing unit makes a search for a route by including the link corresponding to this U-turn path in objects to be searched for. In a case which a link corresponding to a U-turn path is included in the route which has been searched for, the conventional navigation apparatus sets up the route which urges the vehicle to make a U-turn on the road.
[Patent reference 1] JP,10-227649,A

As mentioned above, a problem with a conventional navigation apparatus is that when the vehicle has deviated from the route including a U-turn, the conventional navigation apparatus will present a route acquired through rerouting which is unsatisfactory to the user. A further problem is that the conventional navigation apparatus does not perform rerouting until the vehicle travels over several tens of meters even though the user desires the conventional navigation apparatus to perform rerouting.

The present invention is made in order to solve the above-mentioned problems, and it is therefore an object of the present invention to provide a navigation apparatus that, in a case of presenting a route which urges the vehicle to make a U-turn at a waypoint, can perform rerouting at a timing suitable for the user even if the vehicle has not made a U-turn at this waypoint.

### DISCLOSURE OF THE INVENTION

In order to solve the above-mentioned problems, a navigation apparatus in accordance with the present invention includes: an input unit for inputting a destination and a waypoint; a route searching unit for searching for a route to the destination via the waypoint inputted from the input unit; and a route guidance unit for, in a case in which the route which is searched for by the route searching unit is the one which urges a vehicle to make a U-turn at the waypoint, inhibits execution of rerouting while a predetermined condition is satisfied even if the vehicle has deviated from the route because the vehicle did not make a U-turn at the waypoint.

In a case of presenting the route which urges the vehicle to make a U-turn at the waypoint, the navigation apparatus in accordance with the present invention inhibits execution of a research while a predetermined condition is satisfied even if the vehicle has not made a U-turn at the above-mentioned waypoint. Therefore, because the navigation apparatus in accordance with the present invention can perform rerouting at a timing suitable for the user.

### BRIEF DESCRIPTION OF THE FIGURES

FIG. 1 is a block diagram showing the structure of a navigation apparatus in accordance with Embodiment 1 of the present invention;

FIG. 2 is a functional block diagram showing the details of functions implemented by a CPU shown in FIG. 1;

FIG. 3 is an explanatory drawing explaining the operation of a conventional navigation apparatus in comparison with the operation of the navigation apparatus in accordance with Embodiment 1 of the present invention;

FIG. 4 is an explanatory drawing for explaining the operation of the navigation apparatus in accordance with Embodiment 1 of the present invention;

FIG. 5 is a flow chart showing the operation of the navigation apparatus in accordance with Embodiment 1 of the present invention;

FIG. 6 is an explanatory drawing for explaining the operation of a navigation apparatus in accordance with Embodiment 2 of the present invention;

FIG. 7 is a flow chart showing the operation of the navigation apparatus in accordance with Embodiment 2 of the present invention;

FIG. 8 is an explanatory drawing for explaining the operation of a navigation apparatus in accordance with Embodiment 3 of the present invention; and

FIG. 9 is a flow chart showing the operation of the navigation apparatus in accordance with Embodiment 3 of the present invention.

### PREFERRED EMBODIMENTS OF THE INVENTION

Hereafter, in order to explain this invention in greater detail, the preferred embodiments of the present invention will be described with reference to the accompanying drawings.

### Embodiment 1

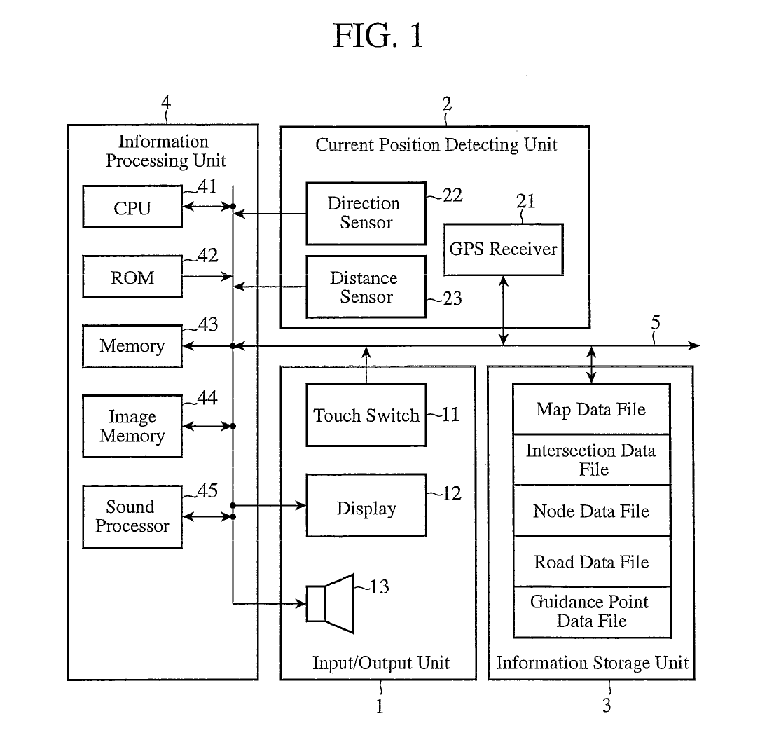

FIG. 1 is a block diagram showing the structure of a navigation apparatus in accordance with Embodiment 1 of the present invention. This navigation apparatus is comprised of an input/output unit 1, a current position detecting unit 2, an information storage unit 3, an information processing unit 4, and a bus 5 for connecting these units to one another.

The input/output unit 1 is used in order to input and output various pieces of information. This input/output unit 1 is provided with a touch switch 11, a display 12, and a speaker 13. The touch switch 11 consists of, for example, a touch panel mounted on the screen of the display 12, and is used for a driver to input data for setting up a place of departure, a destination, a waypoint, a passing point, or the like, and to instruct the information processing unit 4 to output guidance information.

A signal showing the data or the instruction inputted from this touch switch 11 is sent to the information processing unit 4 via the bus 5.

The display 12 consists of, for example, an LCD (Liquid Crystal Display), and displays guidance information on the screen according to an image signal sent thereto from the information processing unit 4. The speaker 13 outputs guidance information by voice according to an audio signal sent thereto from the information processing unit 4.

The current position detecting unit 2 inputs and outputs information about the current position of a vehicle. This current position detecting unit 2 is provided with a GPS (Global Positioning System) receiver 21, a direction sensor 22, and a distance sensor 23.

The GPS receiver 21 detects the current position of the vehicle on the basis of GPS signals received from GPS satellites. The current position of the vehicle detected by this GPS receiver 21 is informed to the information processing unit 4 via the bus 5 as a current position signal. The direction sensor 22 detects the angular velocity of the vehicle at the time when the vehicle is making a turn. The angular velocity detected by this direction sensor 22 is informed to the information processing unit 4 as an angular velocity signal. The distance sensor 23 detects the traveled distance of the vehicle. The traveled distance detected by this distance sensor 23 is informed to the information processing unit 4 as a distance signal.

The information storage unit 3 stores information used for a route search and a route guidance. Concretely, a map data file, an intersection data file, a node information file, a road data file, and a guidance point data file are stored in the information storage unit 3. Audio data used for performing a voice guidance are also stored in the information storage unit 3.

The map data file stores map data used for a route guidance. The intersection data file stores data about intersections. The node information file stores the longitude and latitude coordinates of specified points on roads. The road data file stores information about the types of roads, the start point and end point of each of the roads, etc. The guidance point data file stores the coordinates of positions, such as gas stations and convenience stores, each of which serves as a landmark for guidance.

The information processing unit 4 performs a route searching process and a route guidance process, and also controls this whole navigation apparatus. This information processing unit 4 is provided with a CPU (Central Processing Unit) 41, a ROM (Read Only Memory) 42, a memory 43, an image memory 44, and a sound processor 45.

The CPU 41 performs both the route searching process for implementing a route searching function, and the route guidance process for implementing a route guiding function by operating according to a program stored in the ROM 42, and also performs various processes for controlling this navigation apparatus. The details of the functions implemented by this CPU 41 will be mentioned below.

The ROM 42 stores the program used for implementing the above-mentioned route searching process and route guidance process, etc., and a program and data used for performing a display of a landmark at each guided intersection and display control required for route guidance, a program and data used for performing audio output control required for voice guidance, and display data required for route guidance, a map display, etc. The various programs and data which are stored in this ROM 42 are read by the CPU 41.

The memory 43 is used as a work memory of the CPU 41, and temporarily stores road information acquired through the route searching process or a route researching process (road series data and guided intersection data), route guide information, or data currently being arithmetic-processed. The data stored in this memory 43 are read by the CPU 41.

The image memory 44 stores the image data generated by the CPU 41. The image data stored in this image memory 44 are sent to the display 12 as an image signal. As a result, either a guidance image or a map is displayed on the screen of the display 12. The sound processor 45 reads the audio data from the information storage unit 3 in response to an audio output control command from the CPU 41, synthesizes these read audio data, converts the audio data into an analog signal, and sends the analog signal to the speaker 13 as an audio signal. As a result, a guidance voice is generated from the speaker 13.

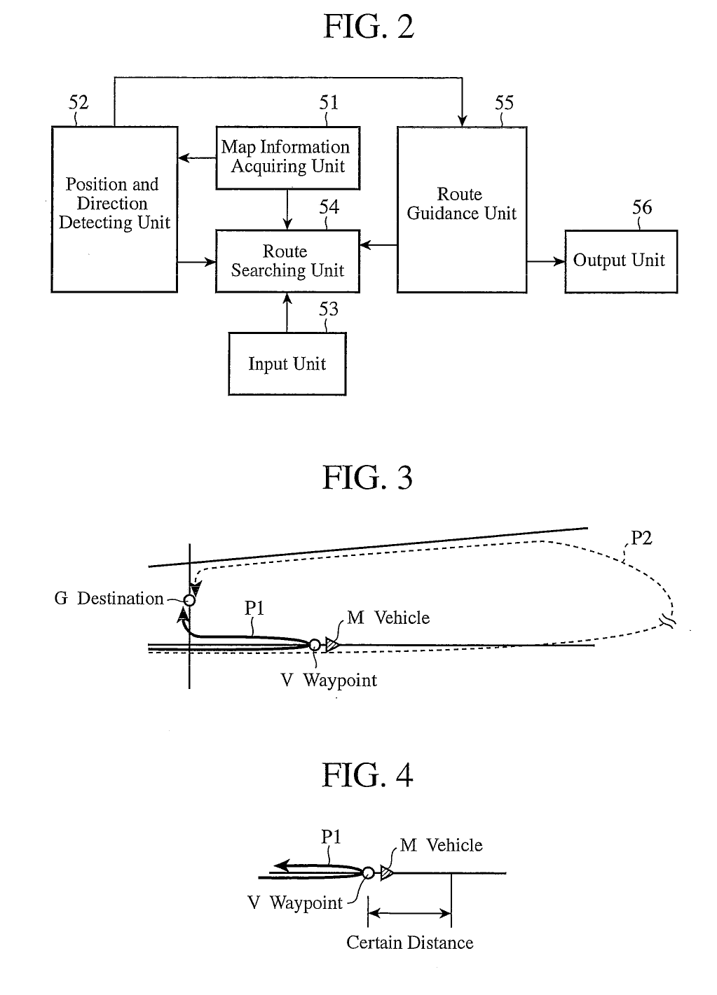

Next, the details of the functions implemented by the CPU 41 will be explained with reference to a functional block diagram shown in FIG. 2. The CPU 41 is comprised of a map information acquiring unit 51, a position and direction detecting unit 52, an input unit 53, a route searching unit 54, a route guidance unit 55, and an output unit 56 which are implemented by the program.

The map information acquiring unit 51 acquires map data from the information storage unit 3. The map data acquired by this map information acquiring unit 51 are sent to the position and direction detecting unit 52 and the route searching unit 54. The position and direction detecting unit 52 detects the current position of the vehicle on the basis of the current position signal sent thereto from the GPS receiver 21 and/or the current position signal which is generated on the basis of the angular velocity signal sent thereto from the direction sensor 22 and the distance signal sent thereto from the distance sensor 23 through autonomous navigation. The current position of the vehicle detected by this position and direction detecting unit 52 is informed to the route searching unit 54 and the route guidance unit 55 as current position data.

The input unit 53 informs the place of departure, and the destination and/or the waypoint which are shown by the signal sent thereto from the touch switch 11 to the route searching unit 54, and also sends a command for starting a route search to the route searching unit 54.

According to the command for staring a route search start sent thereto from the input unit 53, the route searching unit 54 searches for a route extending from the current position informed thereto from the position and direction detecting unit 52 or the place of departure informed thereto from the input unit 53 to the destination inputted from the input unit 53 via the waypoint inputted from the input unit 53 (when the waypoint is inputted) on the basis of the map data acquired by the map information acquiring unit 51. Furthermore, according to a command for rerouting sent thereto from the route guidance unit 55, the route searching unit 54 reroutes the route from the current position informed thereto from the position and direction detecting unit 52, via a waypoint (when a point placed forwardly is set up at the waypoint), to the destination on the basis of the map data acquired by the map information acquiring unit 51. This route which has been searched for by the route searching unit 54 is informed to the route guidance unit 55.

The route guidance unit 55 extracts the guidance points which exist on the route informed thereto from the route searching unit 54 on the basis of the current position data sent thereto from the position and direction detecting unit 52 to generate guidance information, and sends this guidance information to the output unit 56. Furthermore, when judging that the vehicle has deviated from the route informed thereto from the route searching unit 54 on the basis of the current position data sent thereto from the position and direction detecting unit 52, the route guidance unit 55 inhibits execution of any rerouting while a predetermined condition (which will be mentioned below in detail) is satisfied, and, when this predetermined condition is no longer satisfied, instructs the route searching unit 54 to carry out rerouting.

The output unit 56 provides a guidance on the basis of the guidance information sent thereto from the route guidance unit 55. Concretely, the output unit 56 sends the image data which are stored in the image memory 44 as the guidance information to be displayed on the screen to the display 12 as an image signal. As a result, the guidance information is displayed on the screen of the display 12. The output unit 56 also sends the audio output control command to the sound processor 45. The sound processor 45 reads the audio data from the information storage unit 3, synthesizes these read audio data, converts the audio data into an analog signal, and sends the analog signal to the speaker 13 as an audio signal. As a result, the guidance information is outputted by voice from the speaker 13.

Next, the operation of the navigation apparatus in accordance with Embodiment 1 of the present invention constructed as mentioned above will be explained. The navigation apparatus in accordance with this Embodiment 1 is constructed in such a way as to, in a case in which the route which has been searched for by the route searching unit 54 is the one which urges the vehicle to make a U-turn at a waypoint, even if the vehicle has deviated from the route because the vehicle went straight forward along a road without making a U-turn at the waypoint, to inhibit execution of any rerouting until the vehicle is at a certain distance away from the waypoint along the road.

FIG. 3 is a view showing a state in which in a case in which a route P1 extending to a destination G via a waypoint V is presented as the result of the route search, the vehicle M cannot make a U-turn at the waypoint V, but travels in a direction opposite to the direction of the route P1, in other words, the vehicle M goes straight forward along the road, along which the vehicle has traveled until reaching the waypoint V by way of the route P1, just as it has done. In this case, a conventional navigation apparatus provides a guidance to urge the vehicle to make a U-turn when the vehicle reaches the waypoint V, and, when the vehicle then travels over a distance of several tens of meters away from the waypoint V without making a U-turn at the waypoint, judges that the vehicle has deviated from the route P1 and carries out rerouting. As a result, the conventional navigation apparatus may present a route along which the vehicle will have to make a very long detour, e.g., a route P2 as shown in the figure.

In contrast with this, when the vehicle M is within a certain distance from the waypoint V, as shown in FIG. 4, along an extension of the road along which the vehicle has traveled until reaching the waypoint V by way of the route P1, the navigation apparatus in accordance with Embodiment 1 judges that the user is driving the vehicle to travel along the extension of the road while searching for a location where the user can make a U-turn, and therefore continues the guidance to urge the user to make a U-turn and inhibits execution of the rerouting. In this case, a value larger than several tens of meters as mentioned above, e.g., several hundreds of meters can be used as the certain distance.

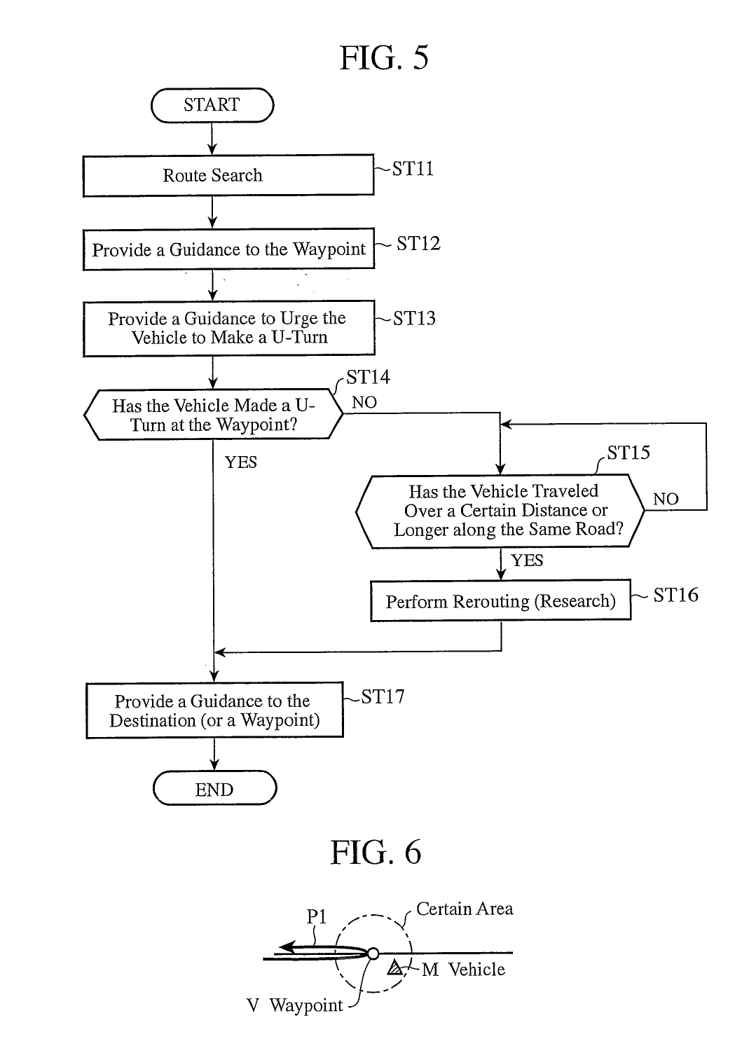

FIG. 5 is a flow chart showing the operation for implementing the functions shown in FIG. 4, which is performed by the navigation apparatus in accordance with Embodiment 1, focusing on the route searching process and the route guidance process. Hereafter, it is assumed that the waypoint V and the destination G have been set up by using the input unit 53.

When a command for starting a route search is inputted from the input unit 53, the navigation apparatus performs a route search first (step ST11). More specifically, according to the command for starting a route search sent thereto from the input unit 53, the route searching unit 54 searches for a route from the current position informed thereto from the position and direction detecting unit 52 or the place of departure informed thereto from the input unit 53, via the waypoint V, to the destination G on the basis of the map data acquired by the map information acquiring unit 51. The route acquired through this search is informed to the route guidance unit 55. In this case, it is assumed that the route acquired through the search is the one which urges the vehicle to make a U-turn at the waypoint V. As a result, a route guidance is started.

When a route guidance is started, the route guidance unit 55 extracts the guidance points from the route informed thereto from the route searching unit 54 on the basis of the current position data sent thereto from the position and direction detecting unit 52 so as to generate guidance information, and sends the guidance information to the output unit 56. As a result, the guidance information is displayed on the screen of the display 12, and is also outputted by voice from the speaker 13.

The navigation apparatus then provides a guidance about the route to the waypoint V (step ST12). After, in this step ST12, guiding the vehicle to the waypoint V, the navigation apparatus provides a guidance to urge the user to make a U-turn at the waypoint (step ST13). More specifically, the route guidance unit 55 generates guidance information for urging the vehicle to make a U-turn at the waypoint V, and sends the guidance information to the output unit 56. As a result, the guidance information is displayed on the screen of the display 12, and is also outputted by voice from the speaker 13.

The navigation apparatus then checks to see whether the vehicle has made a U-turn at the waypoint V (step ST14). The route guidance unit 55 checks to see whether or not the current position shown by the current position data sent thereto from the position and direction detecting unit 52 is on the route informed thereto from the route searching unit 54. When, in this step ST14, judging that the vehicle has made a U-turn at the waypoint V, the navigation apparatus then provides a guidance about the route to the destination (or a waypoint) (step ST17). More specifically, the route guidance unit 55 checks to see whether the vehicle has reached a guidance point on the route informed thereto from the route searching unit 54 on the basis of the current position data sent thereto from the position and direction detecting unit 52, and, when judging that the vehicle has reached a guidance point, generates guidance information and sends the guidance information to the output unit 56. As a result, the guidance information is displayed on the screen of the display 12, and is also outputted by voice from the speaker 13. After that, the navigation apparatus ends the processing.

In contrast, when, in above-mentioned step ST14, judging that the vehicle has not made a U-turn at the waypoint V, the navigation apparatus then checks to see whether the vehicle has traveled over a certain distance or longer along the same road (step ST15). More specifically, the route guidance unit 55 checks to see whether the current position shown by the current position data sent thereto from the position and direction detecting unit 52 is on an extension of the road along which the vehicle has traveled until reaching the waypoint V by way of the route P1. This condition that “the vehicle has not traveled over the certain distance or longer along the same road” corresponds to a predetermined condition according to the present invention.

When, in this step ST15, judging that the vehicle has not traveled over the certain distance or longer along the same road, i.e., the predetermined condition is satisfied, the navigation apparatus returns the sequence to the input side of step ST15 and then provides a guidance to urge the user to make a U-turn and, after that, repeats the above-mentioned processing. Therefore, the navigation apparatus continues the guidance to urge the user to make a U-turn until the vehicle travels over the certain distance or longer along the same road.

In contrast, when, in step ST15, judging that the vehicle has traveled over the certain distance or longer along the same road, i.e., the predetermined condition is not satisfied, the navigation apparatus performs the rerouting (a research) (step ST16). More specifically, the route guidance unit 55 instructs the route searching unit 54 to carry out the rerouting. As a result, the route searching unit 54 reroutes the route from the current position informed thereto from the position and direction detecting unit 52, via a waypoint (when a point placed forwardly is setup at the waypoint), to the destination on the basis of the map data acquired by the map information acquiring unit 51. This route which has been searched for by the route searching unit 54 is informed again to the route guidance unit 55. After that, the navigation apparatus advances the sequence to step ST17 and provides a guidance about the route to the above-mentioned destination (or the waypoint).

As previously explained, when the vehicle is traveling along the same route without making a U-turn at the waypoint V, the navigation apparatus in accordance with Embodiment 1 of the present invention considers that the user is searching for a location which the user can make a U-turn and then inhibits execution of the rerouting which must be unsatisfactory to the user. Therefore, the navigation apparatus in accordance with Embodiment 1 does not present any route unsatisfactory to the user.

The navigation apparatus is constructed in such a way as to, in above-mentioned step ST15, check to see whether the vehicle has traveled over a certain distance or longer along the same road. The navigation apparatus can be alternatively constructed in such a way as to check to see whether the vehicle has traveled over a certain distance or longer along a different road, i.e., another road which is not an extension of the road along which the vehicle has traveled until reaching the waypoint V by way of the route P1. According to this structure, because the navigation apparatus inhibits execution of the rerouting also when the vehicle has not made a U-turn at the waypoint V and has not traveled over a certain distance or longer along a different road branching from this waypoint V, the navigation apparatus does not present any route unsatisfactory to the user.

### Embodiment 2

A navigation apparatus in accordance with Embodiment 2 of the present invention is constructed in such a way as to, in a case in which a route which is searched for by a route searching unit is the one which urges the vehicle to make a U-turn at a waypoint, inhibit execution of a research while the vehicle is within a certain area from the waypoint even if the vehicle has deviated from the route because the vehicle did not make a U-turn at the waypoint.

The navigation apparatus in accordance with this Embodiment 2 has the same structure as the navigation apparatus in accordance with Embodiment 1 shown in FIGS. 1 and 2. Because the navigation apparatus in accordance with this Embodiment 2 can estimate that the vehicle M returns to the route P1 when the vehicle M is within the certain area from the waypoint V, as shown in FIG. 6, the navigation apparatus continues a guidance to urge the vehicle to make a U-turn and inhibits execution of the rerouting. In this case, the certain area can be the interior of a circle having a center at the waypoint V and having a radius of, for example, several hundreds of meters.

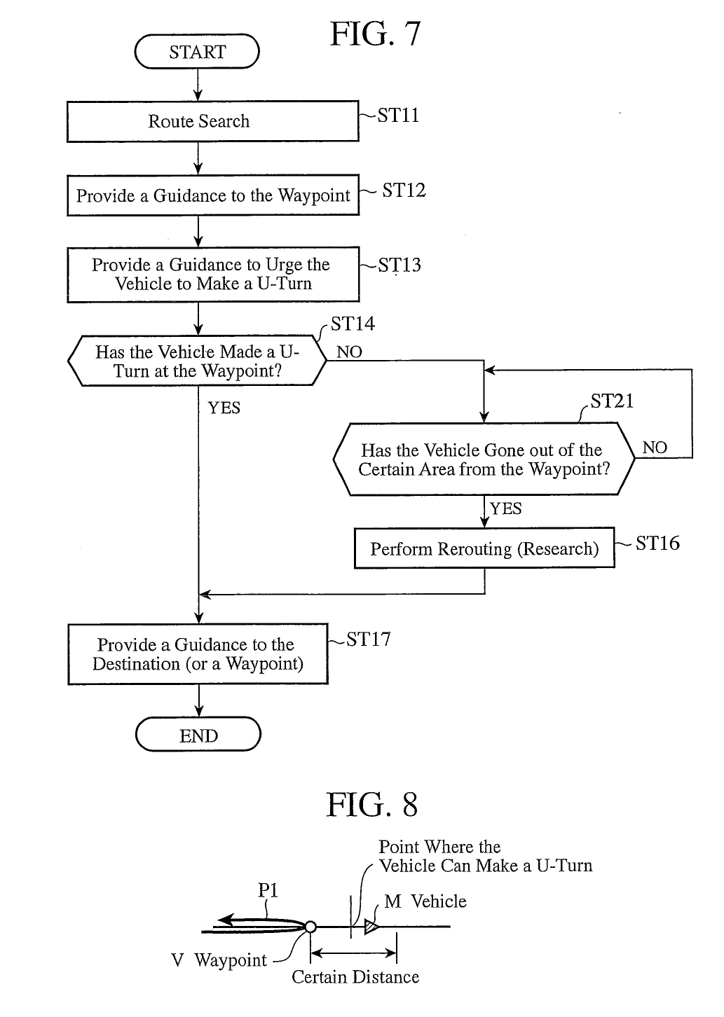

Next, the operation of the navigation apparatus in accordance with Embodiment 2 of the present invention will be explained. FIG. 7 is a flow chart showing the operation for implementing functions shown in FIG. 6, which is performed by the navigation apparatus in accordance with Embodiment 2, focusing on a route searching process and a route guidance process. Hereafter, it is assumed that the waypoint V and a destination G have been set up by using an input unit 53. Steps in which the same processes as those shown in the flow chart shown in FIG. 5 are performed are designated by the same reference characters used in the flow chart of FIG. 5, and the explanation of the steps will be simplified.

When a command for starting a route search is inputted from the input unit 53, the navigation apparatus performs a route search first (step ST11). The navigation apparatus then provides a guidance about the route to the waypoint V (step ST12). After, in this step ST12, guiding the vehicle to the waypoint V, the navigation apparatus provides a guidance to urge the user to make a U-turn at the waypoint (step ST13).

The navigation apparatus then checks to see whether the vehicle has made a U-turn at the waypoint V (step ST14). When, in this step ST14, judging that the vehicle has made a U-turn at the waypoint V, the navigation apparatus then provides a guidance about the route to the destination (or a waypoint) (step ST17). In contrast, when, in step ST14, judging that the vehicle has not made a U-turn at the waypoint V, the navigation apparatus then checks to see whether the vehicle has gone out of the certain area from the waypoint V (step ST21). More specifically, a route guidance unit 55 checks to see whether the current position shown by the current position data sent thereto from a position and direction detecting unit 52 is in the certain area whose center is at the waypoint V. This condition “whether the vehicle has gone out of the certain area from the waypoint” corresponds to the predetermined condition of the present invention.

When, in this step ST21, judging that the vehicle has not gone out of the certain area from the waypoint, i.e., the predetermined condition is not satisfied, the navigation apparatus returns the sequence to the input side of step ST21 and then provides a guidance to urge the user to make a U-turn and, after that, repeats the above-mentioned processing. Therefore, the navigation apparatus continues the guidance to urge the user to make a U-turn until the vehicle goes out of the certain area from the waypoint V.

In contrast, when, in step ST21, judging that the vehicle has gone out of the certain area from the waypoint, i.e., the predetermined condition is not satisfied, the navigation apparatus performs the rerouting (a research) (step ST16). After that, the navigation apparatus advances the sequence to step ST17 and provides a guidance about the route to the above-mentioned destination (or a waypoint).

As previously explained, because the navigation apparatus in accordance with Embodiment 2 of the present invention can estimate that the vehicle M returns to the route P1 when the vehicle M is within the certain area from the waypoint V, the navigation apparatus can inhibit execution of the rerouting which must be unsatisfactory to the user. As a result, the navigation apparatus in accordance with Embodiment 2 does not present any route unsatisfactory to the user.

### Embodiment 3

A navigation apparatus in accordance with Embodiment 3 of the present invention is constructed in such a way as to, in a case in which a route which is searched for by a route searching unit is the one which urges the vehicle to make a U-turn at a waypoint, inhibit execution of a research until the vehicle passes through a certain point where the vehicle can make a U-turn even if the vehicle has deviated from the route because the vehicle did not make a U-turn at the waypoint.

The navigation apparatus in accordance with this Embodiment 3 has the same structure as the navigation apparatus in accordance with Embodiment 1 shown in FIGS. 1 and 2. Because the navigation apparatus in accordance with this Embodiment 3 can estimate that the vehicle M returns to the route P1 until the vehicle passes through a certain point where the vehicle can make a U-turn, as shown in FIG. 8, the navigation apparatus continues a guidance to urge the vehicle to make a U-turn and inhibits execution of the rerouting until the vehicle passes through the certain point where the vehicle can make a U-turn. Conversely, when the vehicle M passes through the “certain point where the vehicle can make a U-turn”, the navigation apparatus in accordance with this Embodiment 3 judges that the user does not intend to return to the route P1, and then performs the rerouting even if the vehicle is at a certain distance or shorter from the via-point (the certain distance is the same as the “certain distance” in Embodiment 1). In this case, the “certain point where the vehicle can make a U-turn” can be a “point where the vehicle can surely make a U-turn” disclosed in patent reference 1.

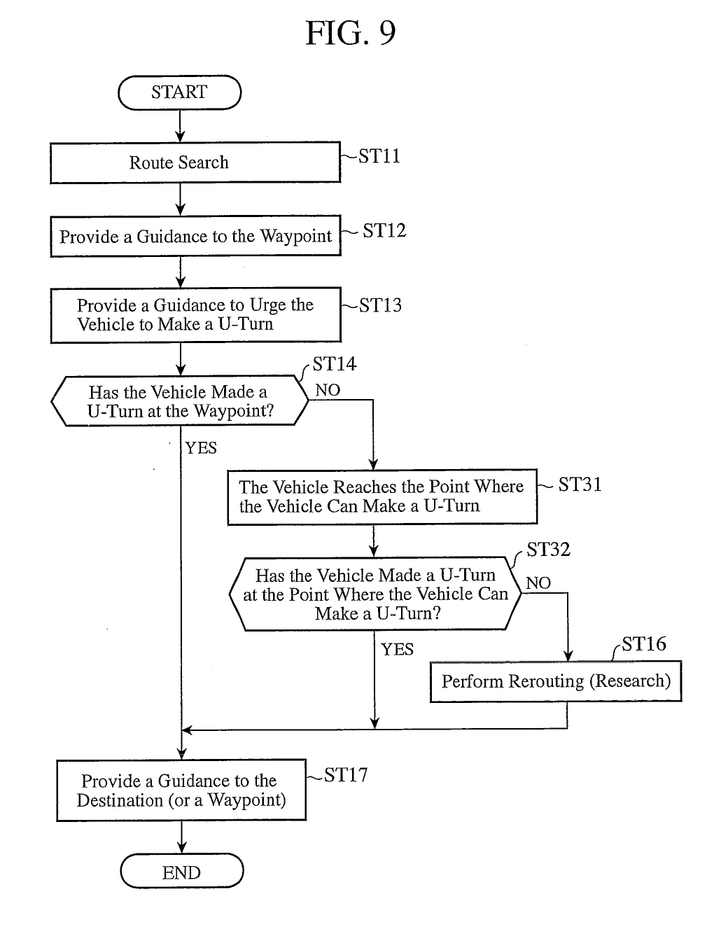

Next, the operation of the navigation apparatus in accordance with Embodiment 3 of the present invention will be explained. FIG. 9 is a flow chart showing the operation for implementing functions shown in FIG. 8, which is performed by the navigation apparatus in accordance with Embodiment 3, focusing on a route searching process and a route guidance process. Hereafter, it is assumed that the waypoint V and a destination G have been set up by using an input unit 53. Steps in which the same processes as those shown in the flow chart shown in FIG. 5 are performed are designated by the same reference characters used in the flow chart of FIG. 5, and the explanation of the steps will be simplified.

When a command for starting a route search is inputted from the input unit 53, the navigation apparatus performs a route search first (step ST11). The navigation apparatus then provides a guidance about the route to the waypoint V (step ST12). After, in this step ST12, guiding the vehicle to the waypoint V, the navigation apparatus provides a guidance to urge the user to make a U-turn at the waypoint (step ST13).

The navigation apparatus then checks to see whether the vehicle has made a U-turn at the waypoint V (step ST14). When, in this step ST14, judging that the vehicle has made a U-turn at the waypoint V, the navigation apparatus then provides a guidance about the route to the destination (or a waypoint) (step ST17). In contrast, when, in step ST14, judging that the vehicle has not made a U-turn at the waypoint V, the navigation apparatus then performs a process of judging that the vehicle has reached the certain point where the vehicle can make a U-turn (step ST31), and then checks to see whether the vehicle has made a U-turn at the certain point where the vehicle can make a U-turn (step ST32). More specifically, a route guidance unit 55 checks to see whether the current position shown by the current position data sent thereto from a position and direction detecting unit 52 has passed through the certain point where the vehicle can make a U-turn. This condition “whether the vehicle has made a U-turn at the certain point where the vehicle can make a U-turn” corresponds to the predetermined condition of the present invention.

When, in this step ST32, judging that the vehicle has made a U-turn at the certain point where the vehicle can make a U-turn, the navigation apparatus advances the sequence to step ST17 and provides a guidance about the route to the above-mentioned destination (or a waypoint). Conversely, when, in step ST32, judging that the vehicle has not made a U-turn at the certain point where the vehicle can make a U-turn, the navigation apparatus recognizes that the user does not intend to return to the route P1, and then performs the rerouting (step ST16). After that, the navigation apparatus advances the sequence to step ST17 and provides a guidance about the route to the above-mentioned destination (or a waypoint).

As previously explained, even when the vehicle has not made a U-turn at the waypoint V, the navigation apparatus in accordance with Embodiment 3 of the present invention can judge that the user does not intend to make a U-turn when the vehicle M passes through the certain point where the vehicle can make a U-turn, the navigation apparatus performs the rerouting and provides a guidance about a new route in this case. Therefore, the navigation apparatus in accordance with Embodiment 3 can present a route according to the user's intention.

### INDUSTRIAL APPLICABILITY

As mentioned above, in a case of presenting a route which urges the vehicle to make a U-turn at a waypoint, the navigation apparatus in accordance with the present invention inhibits execution of a research while a predetermined condition is satisfied even if the vehicle has not made a U-turn at the waypoint. Therefore, because the navigation apparatus in accordance with the present invention can perform rerouting at a timing suitable for the user even when the vehicle has deviated from the route which urges the vehicle to make a U-turn at the waypoint, the navigation apparatus is suitable for use as a car navigation apparatus and so on.

1. A navigation apparatus comprising:
an input unit for inputting a destination and a waypoint;
a route searching unit for searching for a route to the destination via the waypoint inputted from said input unit; and
a route guidance unit for, in a case in which the route which is searched for by said route searching unit is the one which urges a vehicle to make a U-turn at the waypoint, inhibits execution of rerouting while a predetermined condition is satisfied even if the vehicle has deviated from the route because the vehicle did not make a U-turn at said waypoint.

2. The navigation apparatus according to claim 1, characterized in that in the case in which the route which is searched for by said route searching unit is the one which urges the vehicle to make a U-turn at the waypoint, even if the vehicle has deviated from the route because the vehicle went straight forward along a road without making a U-turn at said waypoint, the route guidance unit inhibits execution of the rerouting until the vehicle is at a certain distance or longer away from said waypoint along said road.

3. The navigation apparatus according to claim 1, characterized in that in the case in which the route which is searched for by said route searching unit is the one which urges the vehicle to make a U-turn at the waypoint, even if the vehicle has deviated from the route because the vehicle did not make a U-turn at said waypoint, the route guidance unit inhibits execution of the rerouting while the vehicle is within a certain area from said waypoint.

4. The navigation apparatus according to claim 1, characterized in that in the case in which the route which is searched for by said route searching unit is the one which urges the vehicle to make a U-turn at the waypoint, even if the vehicle has deviated from the route because the vehicle did not make a U-turn at said waypoint, the route guidance unit inhibits execution of the rerouting until the vehicle passes through a point at which the vehicle can make a U-turn.
